(19) United States
(12) Patent Application Publication
(10) Pub. No.: US 2011/0316335 A1
(43) Pub. Date: Dec. 29, 2011

(54) METHOD AND DEVICE FOR OPERATING AN AUTOMATION MACHINE

(75) Inventors: Jochen Bretschneider, Esslingen (DE); Michael Kaever, Erlangen (DE); Michael König, Pyrbaum (DE)

(73) Assignee: Siemens Aktiengesellschaft, 80333 Munchen (DE)

(21) Appl. No.: 12/970,278

(22) Filed: Dec. 16, 2010

(30) Foreign Application Priority Data
Dec. 17, 2009 (DE) 10 2009 054 829.7

(51) Int. Cl. H02J 4/00

(52) U.S. Cl. 307/11

(57) ABSTRACT

An automation machine with a plurality of electric energy loads and a method for operating an automation machine is disclosed. The automation machine is operated by controlling, with a machining program, a machining operation carried out with the automation machine on at least one item and having at least one machining step, determining the active electric power consumed by the plurality of energy loads, and determining from the determined active electric power consumed by the plurality of energy loads the electric energy consumed by the machine or by the plurality of energy loads for at least one of a machined item, a machining step and a pass through the machining program. The lowest electric energy consumption can be determined by comparing different machining operations, with a future machining operation to be controlled with the machining program having the lowest electric energy consumption, enabling energy-efficient operation of an automation machine.

### CROSS-REFERENCES TO RELATED APPLICATIONS

This application claims the priority of German Patent Application, Serial No. 10 2009 054 829.7, filed Dec. 17, 2009, pursuant to 35 U.S.C. 119(a)-(d), the content of which is incorporated herein by reference in its entirety as if fully set forth herein.

### BACKGROUND OF THE INVENTION

The present invention relates to a method for operating an automation machine and to a device for operating an automation machine.

The following discussion of related art is provided to assist the reader in understanding the advantages of the invention, and is not to be construed as an admission that this related art is prior art to this invention.

The topic of “energy efficiency” in automation machines is becoming increasingly important.

It has hitherto only been known practice to display the active electric power of individual motors of the machine (for example the active electric power currently being consumed by the spindle motor, for example, in the case of a machine tool) on the machine.

Furthermore, it is also known practice to display the utilization of individual machine axes of the machine. Start-up tools make it possible to record these data in a trace. This information is currently used to detect and avoid overload situations. Initial ideas for displaying the energy consumption which are currently being discussed in publications are restricted to displaying the energy consumption of the machine if the machine is currently consuming a particular active power from the mains. In order to detect the machine-related energy consumption, a measurement, for example using ammeter clamps or energy meters, is generally resorted to in this case.

It would therefore be desirable and advantageous to obviate prior art shortcomings and to enable energy-efficient operation of an automation machine.

### SUMMARY OF THE INVENTION

According to one aspect of the present invention, a method for operating an automation machine with a plurality of electric energy loads includes the steps of controlling with a machining program a machining operation carried out with the automation machine on at least one item and having at least one machining step determining the active electric power consumed by the plurality of energy loads, and determining from the determined active electric power consumed by the plurality of energy loads the electric energy consumed by the machine or by the plurality of energy loads for at least one of a machined item, a machining step and a pass through the machining program.

According to another aspect of the present invention, a device for operating an automation machine having a plurality of electric energy loads includes a control unit with a machining program with control commands controlling a machining operation carried out by the machine on at least one item, a plurality of drive units connected to the control unit and receiving data from the control unit, wherein the electric energy loads are connected in one-to-one correspondence with the drive units, a plurality of measuring devices associated in one-to-one correspondence with the electric energy loads and measuring active electric power consumed by the electric energy loads, with the measuring devices transmitting the measured active electric power consumed by the electric energy loads to the drive unit for transmission to the control unit, an operating unit connected for data exchange with the control unit, and an evaluation unit connected to the control unit and configured to determine, from the determined active electric power consumed by the plurality of energy loads, the electric energy consumed by the machine or by the plurality of energy loads for at least one of a machined item, a machining step and a pass through the machining program.

Advantageously, the daily electric energy consumed and/or the weekly electric energy consumed and/or the monthly electric energy consumed and/or the energy consumed by the machine and/or the energy loads in a shift and/or the energy consumed by the machine and/or the energy loads in a selected period of time is/are determined. This makes it possible, for example, to compare the energy consumption which has occurred in different shifts.

Advantageously, the electric energy consumed by the machine and/or the electric energy respectively consumed by the energy loads is/are monitored in order to determine whether a respectively associated limit value is overshot or undershot. This makes it possible to detect slowly developing faults, for example as a result of excessive wear on the machine.

Advantageously, the electric energy consumed by the machine and/or the electric energy respectively consumed by the energy loads is/are stored in a manner based on the machining program. This measure makes it possible to store the electric energy consumed in a particular machining program, for example in a database, and to use it for evaluation.

Advantageously, the electric energy consumed by the machine and/or the electric energy respectively consumed by the energy loads is/are compared with consumed electric energy previously stored when running through the same machining program and is/are monitored in order to determine whether a permissible difference between the electric energy and the previously stored electric energy is overshot. This makes it possible to detect slowly developing faults, for example as a result of excessive wear on the machine.

Advantageously, the electric energy consumed by the machine and/or the electric energy respectively consumed by the energy loads is/are compared with at least previously stored electric energy consumed when running through at least one other machining program. This measure makes it possible to determine in a simple manner, for example when there are a plurality of alternative machining programs for machining the item, which machining program consumes the least amount of energy when producing a workpiece from a blank.

Advantageously, in order to control the future machining of the at least one item, use is made of that machining program in which the electric energy consumed by the machine and/or the electric energy respectively consumed by the energy loads is/are lower or, if there is more than one individual other machining program, is/are lowest. This ensures, for example if there are a plurality of alternative machining programs for machining the item, that use is respectively made in future of that machining program which consumes the least amount of energy in order to control the machining of the at least one item.

Advantageously, if the active electric power respectively consumed by the energy loads is determined using electrical and/or mechanical parameters and/or using models and/or by evaluating states of the energy loads. This makes it possible to dispense with additional measuring devices which are needed to determine the active power of the energy loads, with the result that the electric energy consumed is determined using the measuring devices which are present in the machine anyway.

Advantageously, if the electric energy consumed by the machine and/or the electric energy respectively consumed by the energy loads in periods in which the machine is not carrying out a machining operation is/are stored. This measure also makes it possible to concomitantly consider downtimes of the machine when determining the energy efficiency of the machine.

Advantageously, if the electric energy consumed by the machine and/or the electric energy respectively consumed by the energy loads is/are displayed, for example, on the machine. This makes it possible for the user to directly monitor the electric energy consumed, for example in situ on the machine.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic block illustration of an automation machine,

FIG. 2 shows a first continuous load characteristic curve of a motor, and

FIG. 3 shows a second continuous load characteristic curve of a motor.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

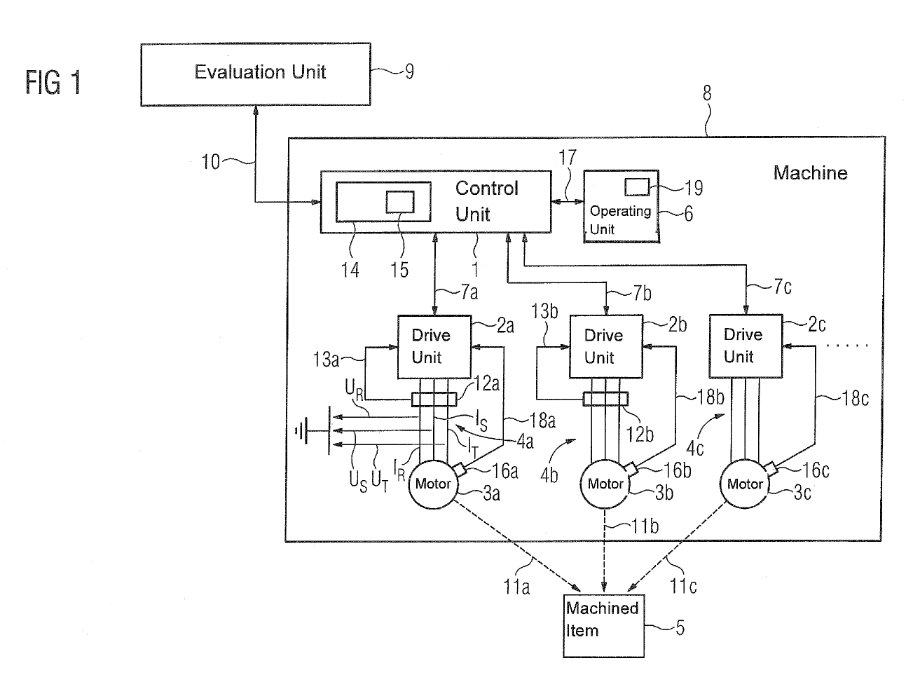

Turning now to the drawing, and in particular to FIG. 1, there is shown an automation machine 8 in a schematic block diagram. Within the scope of the exemplary embodiment, the machine 8 is here in the form of a machine tool, but may also be quite generally in the form of a production machine (for example a printing machine or a plastic injection-molding machine).

FIG. 1 shows only those elements of the machine 8 which are essential to understanding the invention.

The machine 8 has a control unit 1 which is in the form of a CNC controller within the scope of the exemplary embodiment. The control unit 1 controls the machining of an item 5 with a machining program 15 containing the control instructions needed to machine the item 5. In accordance with the machining program 15, the control unit 1 generates desired values for driving the motors of the machine 8. The control unit 1 is connected to drive units 2a, 2b and 2c in order to transmit data, which is illustrated by the three connections 7a, 7b and 7c in FIG. 1. The drive units are connected to the motors via electrical lines 4a, 4b and 4c. In order to drive the respective associated motor 3a, 3b and 3c, the drive units 2a, 2b and 2c each have a regulating system and a power converter. In this case, the desired values are in the form of desired position values in the case of the drive units 2a and 2b, whereas the desired values are in the form of desired speed values in the case of the drive unit 2c. In order to drive the motor 3a, the drive unit 2a generates output voltages U_{R}, U_{S} and U_{T} (conductor ground voltages) using the desired position values generated by the control unit 1 and actual position values of the shaft of the motor 3a, the actual position values being measured by a position encoder 16a and being supplied to the drive unit 2a via a connection 18a. The voltages U_{R}, U_{S} and U_{T} and the motor currents I_{R}, I_{S} and I_{T} are measured using a measuring device 12a and are transmitted, via a connection 13a, to the drive unit 2a which then in turn transmits them to the control unit 1 via the connection 7a.

In order to drive the motor 3b, the drive unit 2b generates output voltages using the desired position values generated by the control unit 1 and the actual position values of the shaft of the motor 3b, the actual position values being measured by a position encoder 16b and being supplied to the drive unit 2b via a connection 18b.

The motor voltages and the motor currents of the motor 3b are measured using a measuring device 12b and are transmitted, via a connection 13b, to the drive unit 2b which then in turn transmits them to the control unit 1 via the connection 7b. In this case, the measuring devices 12a and 12b may also be integrated in the respectively associated drive unit 2a and 2b. For the sake of clarity, the designations of the motor voltages and the motor currents of the motor 3b are not illustrated in FIG. 1.

The position of a tool for machining the item 5, for example, is changed with the aid of the motors 3a and 3b, that is to say the tool is moved. The motors 3a and 3b are thus involved in the machining of the item 5, which is indicated by the dashed arrows 11a and 11b. The motor 3c may be, for example, in the form of a pump motor which is used to drive a pump which moves a cooling liquid used to cool the tool when machining the item 5. As such, the motor 3c is likewise involved in the machining of the item 5, which is illustrated by a dashed arrow 11c in FIG. 1. In order to regulate the speed of the motor 3c, the control unit 1 generates a desired value in the form of a desired speed value and supplies the latter to the drive unit 3c, as an input variable, via the connection 7c. The drive unit 2c generates output voltages for driving the motor 3c in accordance with the desired speed value and actual speed values which are measured by a speed measuring device 16c and are supplied to the drive unit 2c, as an input variable, via a connection 18c.

In order to transmit data, the control unit 1 is connected to an operating unit 6 used to operate the machine 8, which is illustrated by a connection 17. The operating unit 6 has a display 19 on which data generated by the control unit 1 can be displayed, for example. The operating unit 6 may be in the form of a control panel, for example.

In order to store data, the control unit 1 has a data memory 14 which also stores the machining program 15. In order to interchange data, the machine 8 is also connected to a superordinate evaluation unit 9 via a connection 10. The data from a plurality of machines can be evaluated in the evaluation unit 9.

It is noted here that the illustrated motors 3a, 3b and 3c with the respectively associated drive units 2a, 2b and 2c are illustrated only by way of example here and the machine 8 has considerably more motors and associated drive units which are connected to the control unit 1, which is indicated with dots on the right-hand side of FIG. 1.

Within the scope of the exemplary embodiment, the motors 3a, 3b and 3c and the operating unit 6 constitute energy loads of the machine 8. According to the invention, the active electric power respectively consumed by the energy loads is determined, and the electric energy consumed by the machine 8 and/or the electric energy respectively consumed by the energy loads for each machined item and/or for each machining step and/or for each run of the machining program is/are determined from the determined active electric powers of the energy loads of the machine. The active electric power consumed by the motor 3a, the active electric power consumed by the motor 3b and the active electric power consumed by the motor 3c and the active electric power consumed by the operating unit 6 are thus continuously determined. In this case, the active electric power is the electric energy consumed per unit time, for example per second. The active electric power consumed by the machine 8 (total active power) is determined from the active powers of the individual energy loads by adding the active electric powers determined by the individual energy loads.

In order to determine the active electric power consumed by the motor 3a, the voltages and currents measured by the measuring device 12a are transmitted from the drive unit 2a to the control unit 1, and the active electric power consumed at any time is determined from the voltages and currents in the control unit 1. Since the root-mean-square values of the voltages and currents and the phase shift between the voltages and the respectively associated currents are the same, the active electric power P consumed by the motor 3a can be determined as:

P=3U_{Reff}I_{Reff} cos(φ) (1)

where φ is the phase shift between the voltage U_{R} and the current I_{R}, U_{Reff} is the root-mean-square value of the voltage U_{R} and I_{Reff} is the root-mean-square value of the current I_{R}. The voltages and currents of the other two phases are therefore not necessarily needed to calculate the power. However, they can be used to redundantly calculate the power, for example, with the result that, even if the measurement in one phase fails, the active power can still be reliably determined from the voltage and the current of one of the two other phases.

Alternatively, however, preprocessing may also be carried out in the drive unit 2a, with the result that the drive unit 2a calculates the active electric power electrically consumed by the motor 3a, and the active electric power consumed is transmitted from the drive unit 2a to the control unit 1 as a direct value via the connection 7a. The active electric power consumed by the motor 3b is determined in a similar manner.

In order to determine the active power electrically consumed by the motor 3c, there is no measuring system for directly measuring the motor voltages and motor currents within the scope of the exemplary embodiment. In such a case, the active electric power consumed by the relevant energy load can be determined, for example, using electrical and/or mechanical parameters and/or using models which simulate or estimate the active electric power consumed by the energy loads and/or by evaluating states of the energy load.

In the case of the exemplary embodiment, the active electric power P consumed by the motor 3c is determined approximately using the speed n of the motor 3c, as determined by the rotary encoder 16c, and an assumed essentially constant torque M, which must be applied by the motor 3c, in accordance with the relationship

P=M·2π·n (2)

while disregarding efficiency losses. If the efficiency of the motor is known, it can be concomitantly taken into account when calculating the active electric power P in order to determine the active electric power P in a more accurate manner.

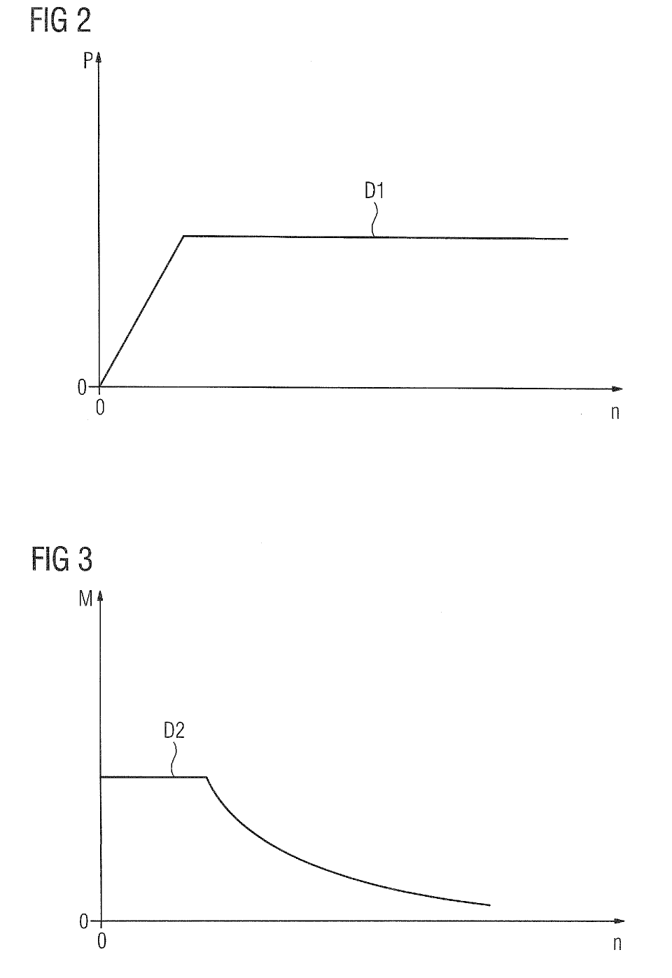

If, for example, only the speed n of a motor is known, the active power consumed by the motor can be determined, for example, with the aid of a model which uses the speed n to determine, for example, the maximum possible active electric power consumed by the motor at the relevant speed, and, as such, as part of an estimation according to the above. In this case, the model may be, for example, in the form of the continuous load characteristic curves D1 and D2 illustrated in FIG. 2 and FIG. 3. For example, the maximum possible active electric power consumed at the relevant speed n can be determined using the continuous load characteristic curve D1 for the speed n of the motor while disregarding the efficiency losses.

Furthermore, the maximum possible torque M generated by the motor at the relevant speed n can be determined, for example, using the continuous load characteristic curve D2 for the speed n of the motor, and the maximum possible active electric power consumed by the motor can be determined using the relationship below, while disregarding the efficiency losses, as

$$P = \frac{M \cdot n}{9549.3} .$$

The number of 9549.3 represents the conversion factor between the units Nm and Ws.

The active electric power consumed by the operating unit 6 can be measured once, for example upon start-up, using an active power measuring device temporarily installed in the machine for this purpose and the active power consumed by the operating unit 6 and measured in this case can be stored in the data memory 14, with the result that the control unit 1 knows that, when the operating unit 6 is operating, it consumes this previously determined active power. If necessary, the active power consumed by the operating unit 6 can be measured once with the display 19 switched on and once without the display 19 switched on, and the operating unit 6 informs the control unit 1 at any time, via the connection 17, whether or not the display 19 is currently switched on, with the result that the control unit 1 can use the correct value for the active electric power currently consumed by the operating unit 6 from its data memory. In a corresponding manner, different active electric powers consumed can also be stored in a table for different brightness settings of the display, and the associated active electric power is taken from the table depending on the currently set brightness of the display and the active electric power consumed is determined in this manner.

The active power consumed by the drive units 2a, 2b and 2c and by the control unit 1 can also be determined in a similar manner to the determination of the active electric power consumed by the operating unit 6, depending on how accurately the active electric power consumed by the machine 8 (total active electric power consumed by the machine) is intended to be determined, and can be stored in the data memory 14. In this case, the active electric powers consumed by the drive units 2a, 2b and 2c mean the active electric powers consumed for the drive units' own consumption, that is to say the active electric powers consumed by the drive units 2a, 2b and 2c when the motors are switched off.

Furthermore, in the case of energy loads which have an essentially constant energy consumption, for example, it is also possible to measure the active electric power consumption once during the supply for the entire machine and to then determine the active electric powers consumed by the individual energy loads by deliberately switching individual energy loads on and off and to store the active electric powers consumed by the individual energy loads, as determined in this manner, in the data memory 14, for example. The control unit 1 can then determine the active electric powers consumed by the individual energy loads using the stored active electric powers of the individual energy loads and the information relating to whether the latter are currently switched on.

The machining of the item 5 by the machine 8 is controlled using the machining program 15. In this case, the latter comprises a plurality of machining steps which may be defined by an individual instruction or a plurality of instructions in the machining program 15. For example, a machining step may comprise a particular machining operation, for example smoothing or a drilling operation, or else may only comprise the movement of the tool, for example, from a position X to a position Y.

After the machining program has been run through, the machining of the item is generally ended by the machine and the machining program can be run through again in order to machine a further item of identical construction. The item may be in the form of a blank, for example, which is machined by the machine, for example by means of milling. However, the item may also be, for example, in the form of a paper reel, for example when the machine is in the form of a printing machine.

According to the invention, the electric energy consumed by the machine and/or the electric energy respectively consumed by the energy loads for each machined item and/or for each machining step and/or for each run of the machining program is/are determined from the determined active electric powers consumed by the energy loads of the machine. For this purpose, within the scope of the exemplary embodiment, the control unit 1 integrates the determined active electric powers consumed by the energy loads of the machine over time t for the period of time T for which the respective machining step or the respective machining program or the machining of the item lasted.

$$W = {\int }_{0}^{T} P d t$$

W: electric energy consumed
P: active power.

For example, the electric energy consumed by the machine and/or by individual energy loads of the machine for each machined item in the machine can be determined. It is noted at this point that, if appropriate, a plurality of items may also be simultaneously machined by the machine during one run of an individual machining program, with the result that the energy consumption for each machined item and the energy consumption for each run of the machining program may have different values.

The electric energy consumed by the machine 8 (total energy consumption of the machine) and/or the electric energy respectively consumed by the energy loads 3a, 3b, 3c and 6 is/are displayed on the operating unit 6 in situ on the machine within the scope of the exemplary embodiment. The operator of the machine 8 can thus immediately discern the amount of energy consumed when machining the item 5, for example with the machining program V. He can then subsequently modify the machining program V, for example, by arranging particular machining steps, if possible, in a different order or changing the order of particular machining steps. For example, the machining operation can be carried out at a correspondingly higher speed, with the result that the electrical power consumed increases but the corresponding drilling operation can be carried out more quickly and thus the period of time T during which the electrical power is consumed becomes shorter. He can then have the machining operation run through again with the alternative machining program which has been changed in this manner and can see on the operating unit 6 which of the two machining programs has the lower energy consumption. For the future machining of the item, it is then always possible to use that machining program which requires the lowest energy consumption in order to produce a particular workpiece from a blank. In this manner, it is possible to test various alternative machining programs which all produce a desired workpiece, as the machining result, from a particular predetermined blank.

In order to implement this functionality, the control unit 1 stores the electric energy consumed by the machine and/or the electric energy respectively consumed by the energy loads in a data memory device 14 in a manner based on the machining program. Within the scope of the present invention, storage in a manner based on the machining program means that the electric energy consumed by the machine and/or the electric energy respectively consumed by the energy loads is/are stored in such a manner that, when subsequently calling up the stored data, it is possible to determine the run of which machining program during which the electric energy was stored, that is to say which machining program the stored electric energy belongs to.

The energy data stored in this manner may be analyzed, for example within the scope of a database functionality, and may be transmitted, via a connection 10, to a superordinate evaluation unit 9 which collects and evaluates the energy data.

Within the scope of the exemplary embodiment, the electric energy respectively directly consumed by the energy loads is then compared with at least previously stored electric energy consumed when running through at least one other machining program which is likewise used to control the machining of the at least one item. This comparison can be carried out, for example, by the machine operator or else may also be carried out in an automated manner by the machine itself, for example by the control unit 1.

In order to control the future machining of the at least one item, use is then made of that machining program in which the electric energy consumed by the machine and/or the electric energy respectively consumed by the energy loads is/are lower or, if there is more than one individual other machining program, is/are lowest. The other machining programs are generally alternative machining programs which produce a desired workpiece from a particular blank, for example, but do so with the aid of changed machining steps, machining technologies or machining parameters.

In this case, the machining program can be selected either manually by the operator of the operating unit 6 or else automatically by the machine, in particular by the control unit 1. In this case, the individual alternative machining programs are stored in the data memory 14.

Within the scope of one advantageous embodiment of the invention, the electric energy consumed by the machine and/or the electric energy respectively consumed by the energy loads in periods in which the machine is not carrying out a machining operation is/are also stored in the data memory device in this case. The energy consumption in the event of technical or organizational faults or intended interruptions in the production process can be concomitantly taken into account in this manner, for example.

Furthermore, it is also preferably possible to determine the daily, weekly and/or monthly electric energy consumed by the machine and/or the energy loads and/or the electric energy consumed by the machine and/or the energy loads in a shift and/or in a selected period of time.

Furthermore, the electric energy consumed by the machine and/or the electric energy consumed by the energy loads is/are preferably monitored in order to determine whether a respectively associated limit value is overshot or undershot. If the respectively associated limit value is undershot or overshot within the scope of the exemplary embodiment, a warning message is displayed on the operating unit. If a limit value is overshot, this indicates a worn component of the machine 8, for example, whereas, if a limit value is undershot, this indicates a motor which is no longer operating properly. In this case, one limit value is monitored for overshooting and another limit value is monitored for undershooting. This also makes it possible to detect faults in the machine which are established over a longer period of time.

Furthermore, the electric energy consumed by the machine and/or by the respective energy loads is preferably compared with associated consumed electric energy previously stored when running through the same machining program and is monitored in order to determine whether a permissible difference between the determined electric energy and the previously stored electric energy is overshot. If the difference overshoots a predetermined limit value, a warning message is generated on the operating unit 6.

If appropriate, the machining of the item can also be stopped, for example by the control unit 1, in addition to or instead of the warning message in the two monitoring processes addressed in the preceding paragraphs.

In this case, different levels of detail relating to the electrical energies determined can be displayed on the operating unit 6 depending on the qualification of the operator. For example, it is possible to display basic information for normal machine operators and to display extended detailed information for start-up engineers and service staff.

Within the scope of the exemplary embodiment, the machine 8 and, in particular, the control unit 1 have a network interface via which the energy data determined in this manner can be transmitted to a superordinate evaluation unit 9 for further evaluation. The superordinate evaluation unit 9 can then be used to optimize overall production sequences in which a plurality of automation machines are involved, for example the overall production sequence of a factory, in terms of the lowest possible energy consumption.

It is noted at this point that, within the scope of the invention, the term “automation machine” is understood as meaning not only an individual machine but also a production line comprising a plurality of individual machines which work together.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for operating an automation machine having a plurality of electric energy loads, comprising the steps of:
controlling with a machining program a machining operation carried out with the automation machine on at least one item, the machining operation having at least one machining step,
determining the active electric power consumed by the plurality of energy loads, and
determining from the determined active electric power consumed by the plurality of energy loads the electric energy consumed by the machine or by the plurality of energy loads for at least one of a machined item, a machining step and a pass through the machining program.

2. The method of claim 1, further comprising the steps of:
monitoring the electric energy consumed by the machine or by the plurality of energy loads, and
determining whether an associated limit value for the electric energy is overshot or undershot.

3. The method of claim 1, wherein the electric energy consumed by the machine or the plurality of energy loads is stored in a manner commensurate with the machining program.

4. The method of claim 3, further comprising the steps of:
comparing the electric energy consumed by the machine or the plurality of energy loads with previously consumed electric energy that was stored when making a prior pass through the same machining program,
monitoring a difference between the consumed electric energy and the stored electric energy, and
determining whether the monitored difference exceeds a permissible difference.

5. The method of claim 3, further comprising the step of:
comparing the electric energy consumed by the machine or the plurality of energy loads with previously consumed electric energy that was stored when making a prior pass through at least one different machining program.

6. The method of claim 5, further comprising the step of:
determining a lowest electric energy consumption from the comparison, and
controlling a future machining operation with the machining program having the lowest electric energy consumption.

7. The method of claim 1, wherein the active electric power consumed by the energy loads is determined using at least one of electrical and mechanical parameters, models and an evaluation of states of the energy loads.

8. The method of claim 1, further comprising the step of:
storing the electric energy consumed by the machine or the plurality of energy loads during a time period when the machine is not performing a machining operation.

9. The method of claim 1, further comprising the step of:
displaying the electric energy consumed by the machine or the plurality of energy loads.

10. A device for operating an automation machine having a plurality of electric energy loads, comprising:
a control unit comprising a machining program with control commands controlling a machining operation carried out by the machine on at least one item,
a plurality of drive units connected to the control unit and receiving data from the control unit, wherein the electric energy loads are connected in one-to-one correspondence with the drive units,
a plurality of measuring devices associated in one-to-one correspondence with the electric energy loads and measuring active electric power consumed by the electric energy loads, with the measuring devices transmitting the measured active electric power consumed by the electric energy loads to the drive unit for transmission to the control unit, and
an evaluation unit connected to the control unit and configured to determine, from the determined active electric power consumed by the plurality of energy loads, the electric energy consumed by the machine or by the plurality of energy loads for at least one of a machined item, a machining step and a pass through the machining program.

11. The device of claim 10, further comprising an operating unit connected for data exchange with the control unit.

12. The device of claim 11, wherein the operating unit comprises a display.
